(19) United States
(12) Patent Application Publication
(10) Pub. No.: US 2006/0265638 A1
(43) Pub. Date: Nov. 23, 2006

(54) Fill Form with Computer (Comp-Fill)

(75) Inventor: Polchai Phanumphai, Bangkok (TH)

Correspondence Address: RACHASAK PHANUMPHAI, 9417 E. ARIZONA PLACE, DENVER, CO, 80247, US

(73) Assignee: Polchai Phanumphai, Bangkok (TH)

(21) Appl. No.: 11/161,580

(22) Filed: Aug. 8, 2005

(30) Foreign Application Priority Data
May 18, 2005 (TH) 100685

(51) Int. Cl. G06F 17/24

(52) U.S. Cl. 715/507

(57) ABSTRACT

The purpose of this invention is to ease the process of filling in the blank spaces on the paper form (worksheet) by using a computer's printer. This invention utilizes transparency sheet that contains a table with rows and columns (cells) formatted to be identical as computer application being displayed on the monitor. A user would put this transparency on top of the form that he/she needs fill-in desire words/characters in blank spaces, and type desire words/characters into the cell (coordinate) that he/she can sees through the transparency. Before putting the transparency onto the form, a user may creates some reference mark points on the form to make sure that the printer will prints onto the exact location of the paper form, these reference mark points have to be in the same location as in the transparency while a user is seeing through the cell while filling-in desire words/characters in the blank spaces on the paper form.

Currently, in order to fill a paper form nicely without using handwriting, we may have to use a typewriter, which most people don't have, or use a computer but because of the difficulties of filling such important official forms such as legal, medical, or employment forms, it is critical that these forms must be organized, easy to read, and easy to understand.

In modern technology, using a computer to fill out paper form, can takes time, effort, trial and error to fill these forms out perfectly; this is the reason why, this invention is the answer to help people to fill in the blank paper form easier, user friendlier, and faster by using a personal computer and print it out.

Some computer applications have a function that tells the location of a cursor but these applications are not accurate enough to actually pin point the location of a cursor to be able to fill in the blank spaces on a form accurately, this invention will help increasing its accuracy.

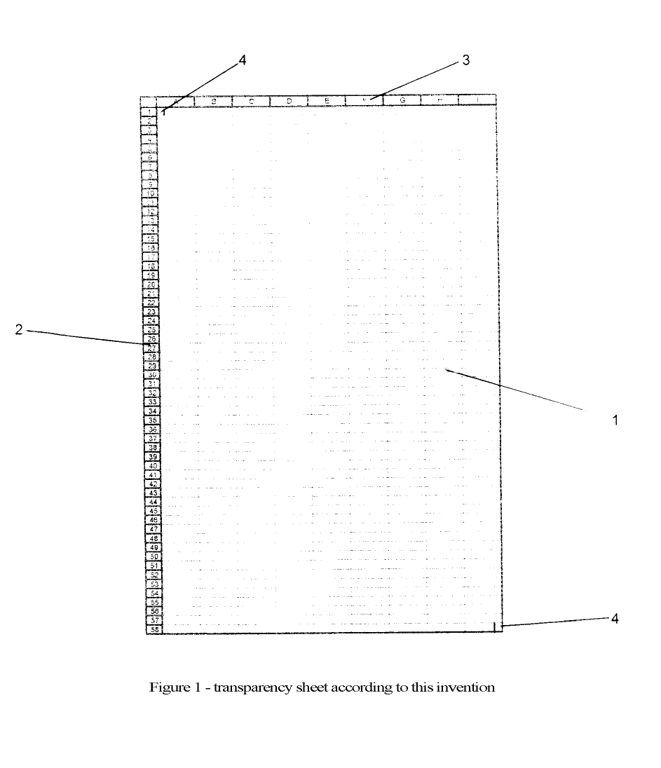

FIG. 1-transparency sheet according to this invention

A diagram of an application displaying on a computer's monitor, this application is consisting of areas for typing words/characters 1, row indicator 2, and column indicator 3. A user can types any words/characters onto any of these cells (coordinate of row 2 and column 3), sends command to print, and the printer will prints these words/characters onto a paper form at the exact same position as seen on the computer's monitor. The following are steps of using Comp-fill according to this invention:
(1) A user would lay a transparency sheet on top of the form
(2) Locate the coordinate typing area
(3) Type desire words/characters, puts the form into printer, and command to print
(4) The printer will prints words/characters onto the blank spaces of the form

The process above may not be accurate enough; this is due to the mechanism inside different printers that can cause words/characters to shift while printing. In order to solve this problem and make this process to be more accurate, a user can create at least one location of reference mark point(s) 4, which must be marked on both transparency sheet and paper form to be at the same position. See procedures below:
(1) A user puts the paper form into the printer, create at least 1 mark in the same location that's already provided on the transparency, this mark can be an asterisk “*” (this asterisk is then became a reference mark point).
(2) Command the computer to print
(3) Once finished printing process, put the transparency sheet on top of the form
(4) Align these reference mark point(s) on the transparency to the marked point on the form. If all of them able to match each others, start typing by reading the coordinate through the transparency until finish and go to step “h”.
(5) Before typing the desire words/characters, the reference mark point on both transparency and form, only the one that's nearest to typing row or row and column must be aligned together.
(6) Start typing desire words/characters
(7) Repeat step “e” and “f” if user have more than one blank spaces on paper form
(8) Insert form into the printer and command to print; these words/characters will be printed onto the form in the exact location as the user expected

The process mentioned above will leave reference mark point(s) on the paper form, this reference mark point(s) can be removed by using white ink after finished.

Another method that will not leave any marks on the form is by printing the reference mark point(s) on a blank sheet of paper or blank transparency that has the same size as the form, put it under the form with all corners aligned together but incase of transparency is used, its able to put on top of the form and follow steps “a” though “h” above.

What is claimed is:

1. The Fill Form with Computer (Comp-Fill) in this invention is consisting of a transparency sheet that has a table diagram; this table diagram is consisting of reference mark point(s), typing area, row indicator, and column indicator, which looks exactly the same as the software that displays on the computer's monitor; it is to be used for putting on top of the form that have already been printed reference mark point(s), align the reference mark point(s) of on both transparency sheet and form together before reading the coordinate of blank spaces on the form through the transparency to fill in the desire words/characters.

2. The Fill Form with Computer (Comp-Fill) as mentioned in claimed 1, where the said reference mark point(s) in the typing area is/are the position of printing the mark for using as reference point(s) on the form, blank paper, or blank transparency, that needs to be aligned at the same position on the transparency sheet as mentioned in claim 1 for the purpose of locating the exact coordinate that the printer will prints.

3. The Fill Form with Computer (Comp-Fill) as mentioned in claim 2, where the said blank sheet of paper or blank transparency has to be in the exact same size as the form, it is to be used for printing reference mark point(s), instead of on the form itself.
